(19) United States
(12) Patent Application Publication
(10) Pub. No.: US 2013/0096307 A1
(43) Pub. Date: Apr. 18, 2013

(54) METHOD OF SYNTHESIZING A COMPLEX [CO (NNS) 2] ACTIVE AGAINST THE MALARIA PARASITE PLASMODIUM

(71) Applicant: Enos Kiremire, Windhoek (NA)

(72) Inventor: Enos Kiremire, Windhoek (NA)

(73) Assignee: UNIVERSITY OF NAMIBIA, Windhoek (NA)

(21) Appl. No.: 13/642,698

(22) PCT Filed: Nov. 19, 2010
(86) PCT No.: PCT/IB2010/055284

§ 371 Date: Dec. 28, 2012

(30) Foreign Application Priority Data
Apr. 23, 2010 (NA) 2010/0011

(51) Int. Cl. C07F 15/06

(52) U.S. Cl. CPC C07F 15/065
USPC 546/6

(57) ABSTRACT

Metal complex of Cobalt (11) containing a dithio-based ligand have been synthesized and characterized by elemental analysis, mass spectrometry, Proton NMR and FT-IR spectrometry. A single crystal X-ray structure of the cadmium complex has been analyzed. The metal complex was subjected to biological tests on falcipain-2 (FP-2) and falcipain-3 (FP-3) cysteine protease enzymes from the malaria parasite Plasmodium falciparum. They were further tested in vitro against chloroquine resistant strain (W2). Whereas the potency of the metal complexes was weaker than the control regarding the FP-2 and FP-3, the potency of metal complexes was found to be exceedingly greater than the control when tested against the chloroquine resistant strain (W2) with a strength ratio of (0.5). This paper describes the synthesis, characterization and biological results of the said metal complex containing the deprotonated 3-[1-(2-pyridyl) ethylidene] hydrazinecarbodithioate ligand (FIG. 1).

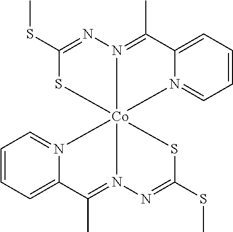

### RELATED ART

Malaria annually kills more than one million people world-wide 90% of them in Africa. The eradication of malaria continues to be frustrated by the continued drug resistance of the malaria parasite. Hence, there is a great need to continue the search for more effective drugs in terms of activity and the cost. The use of metal complexes as pharmaceuticals has shown promise in recent year's particularly as anticancer agents and as contrast agents for magnetic resonance imaging. In the search for novel drugs against resistant parasites, the modification of existing drugs by coordination to metal centers has attracted considerable attention. However, the potential of metal complexes as antiparasitic agents has far been very little explored. As part of our research to develop metal complexes with potential antiprotozoal activities, we present the synthesis and characterization and of metal complex of CoL₂ with high biological activity against the chloroquine resistant strain of the plasmodium falciparum parasite.

### BRIEF DESCRIPTION OF INVENTION

The metal complexes were synthesized and recrystallized. They were sent for spectroscopic measurements. The elemental analyses were performed by using an EA 1108 CHNS-O instrument. The proton NMR was recorded at ambient temperature with Varian mercury (300 MHz) or Varian Unity Spectrometer (400 MHz) and TMS was used as an internal reference. The chemical shifts ( )are given in parts per million relative to TMS (=0.00). The mass spectra were recorded by means of a low resolution mass spectroscopy apparatus. The infrared spectra were measured in solution using chloroform on a satellite Perkin-Elmer FT-IR spectrophotometer.

The current invention present a method of synthesis and characterization of a metal complex, CoL₂. The cobalt chloride hexahydrate, CoCl₂.6H₂O (0.264 g) was dissolved in water (5.0 cm³) to give a pink solution. The dithio containing ligand LH (0.50 g) was also dissolved in warm ethanol (80.0 cm³) to give a pale yellow solution. The cobalt solution was added to the ligand solution and a dark-brown mixture was obtained. Addition of water resulted into the production of a brownish-orange precipitate. The precipitate was filtered off, washed with water, ethanol and ether and then dried at the water pump for 30 minutes. The yield obtained was 0.56 g. The complex was then recrystallized from acetone. Yield 0.45 g (80%). Thiosemicarbazones and their corresponding thiosemicarbazides containing 2-acetylpyridine fragment have been found to show biological activity against malaria parasites, trypasomiasis, bacteria, and viruses. Our current findings indicate that the metal complexes containing the dithioester 3-[1-(2-pyridyl)ethylidene]hydrazinecarbodithioate have moderate potency against falcipain-2 (FP-2) and falcipain-3 (FP-3) cysteine protease enzymes from the malaria parasite plasmodium falciparum while they portray enormous potency against the chloroquine resistant strain (W2) of the parasite. This patent describes the synthesis, characterization and biological results of metal complexes containing deprotonated 3-[1-(2-pyridyl) ethylidene] hydrazinecarbodithioate ligand (FIG. 1). The metal complex were synthesized and recrystallized. The biological activities (nanomolar) of the metal complex against malaria parasites were tested and tabled as Table 1 in FIG. 6 of the drawings. The metal potency was far much greater than the control drug with respect to W-2 . This observation is extremely important as malaria resistance against the chloroquine drug is a great challenge today. This metal complex may act as lead compounds for developing future malaria drugs . The potency of the metal complex is modest and less then that of the control drug with respect to FP-2 and FP-3 cysteine protease enzymes. The potency of Cobalt is greater than that of Ni and Fe with respect to W-2 compared to other metals as well as the control drug. The metal complex CoL₂ containing the deprotonated dithioester L- have been synthesized and characterized by elemental analysis, mass spectrometry, proton NMR and Fourier transform IR. The ligand LH undergoes tautomerism which can readily get ionized to generate a deprotonated ligand L⁻. Both LH and L⁻ are potentially tridentate via the pyridine ring nitrogen, the methine nitrogen (-nitrogen) and the sulphur (mercapto sulphur) atom⁷⁻⁸ . FIG. 2 shows the deprotonation process and mode coordination of L⁻. The analytical data and molecular masses of the complexes are given in FIG. 5, Table 1. This information is consistent with the formulation of the synthesized complex as ML₂ (M =Co)

The x-ray single crystal structure analysis was done for CoL₂ complex, FIG. 10

The structure is a distorted octahedral geometry and indicates that the L⁻ behaves as a tridentate ligand (NNS). It is quite clear that the fragmentation of the complexes involved the bound deprotonated ligand L⁻. The main decomposition points are indicated in FIG. 3.

The coupling of the pyridine hydrogen rings according to FIG. 4.

The results of the biological activities of the metal complexes against malaria parasites are shown in FIG. 6. The metal complex was tested against two cysteine protease enzymes falcipain-2 (FP-2) and falcipain-3 (FP-3) as well as the chloroquine-resistant strain from the malaria parasite Plasmodium falciparum. The following activity sequences can be discerned.

FP-2: CONTROL>Co

FP-3: CONTROL>Co

W-2 Co>CONTROL

Although the metals were bound to the same ligand, L⁻, their activities differed

Dramatically CoL₂ complex yielded a nanomolar strength ratio of 27,010 against FP-2 and 29,720 against FP-3 and 752. 3 against W2 and 3, 3 against W-2 . It is quite clear from our work that keeping the ligand constant and varying the central metal atom, affects the biological activity of the complex.

It is also well known that a change in molecular structure may influence its biological activity dramatically. The biological activity may either remain the same, decrease, increase or disappear completely. This has been observed in thiosemicarbazones and thiosemicarbazides in the malaria studies. For instance, the 2-acetylpyridine moiety in thiosemicarbazones has been found to be crucial in promoting the biological activity against malaria parasites and Trypanosoma rhodesiense and so was the presence of the sulphur atom. The modifications at the pyridine nitrogen and/or the terminal nitrogen (N4) of the thiosemicarbazone chain also affected the biological activity against malaria, trypanosomiasis, and Herpes Simplex Virus. The molecular geometry is also crucial in determining the biological activity in metal complexes.

This is illustrated by cis-[PtCl₂(NH₃)₂] (Cisplatin) is biologically active and used as a drug against cancer whereas the trans isomer is biologically inactive against cancer. Dissociative mechanism of the Cl ligands was advanced to explain the anti-tumor activity in cis-[PtCl₂(NH₃)₂] complex. In this mechanism one of the Cl ligand is replaced by water to form [Cl(H₃N)₂Pt(OH₂)]⁺ complex. Then the platinum aquo complex reacts further with a DNA ‘molecule’ of the cancerous cell to form the new complex [Cl(H₃N)₂Pt(DNA)]⁺ and in so doing terminates or minimizes the cancerous growth. The DNA molecule binds the platinum metal via the guanine moiety. Green and Berg also observed that the retroviral nucleocapsid from the Rauscher murine leukemia binds to metal ions; in particular, it has a higher affinity²⁶ for Co²⁺ and Zn²⁺. In this case the nucleocapsid behaves as a ‘ligand’ for the metal ions. It is also very interesting to note that complexation mechanism has been advanced to explain the anti-malarial activity of chloroquine. It does this by binding the heme fragments and thereby preventing the crucial polymerization process of the parasite. This ultimately leads to the death of the parasite. In this case the chloroquine molecule acts as a ligand to bind the biological heme fragment. Circular dichroism studies of [MLCl] (M =Pd, Pt, L =methyl-3[2-pyridylmethylene] hydrazinecarbodithioate ion) with DNA also indicate that an adduct is formed between the two moieties. Biological activities of certain thiosemicarbazone ligand complexes were found to be less active against malaria parasites than other ligands. On the other hand, it was observed that metal complexes of pyridoxal semicarbazones, thiosemicarbazones and isothiosemi-carbazones were more biologically active than the others ligands.

### POSSIBLE MECHANISM OF THE BIOLOGICAL ACTIVITY OF CoL₂ COMPLEX

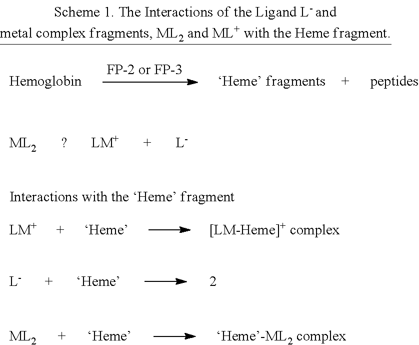

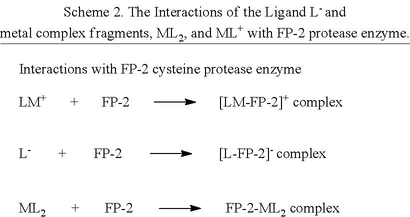

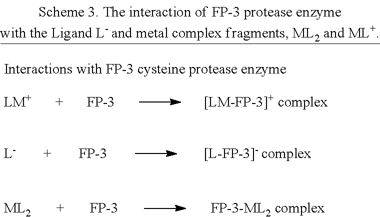

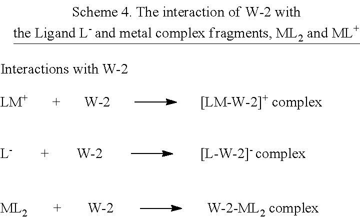

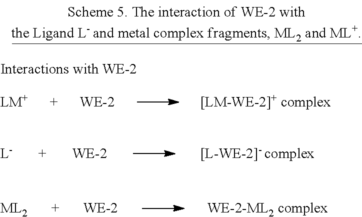

In view of the information about the activity of chloroquine against malaria parasite and that of cis-platin complex, cis-[PtCl₂(NH₃)₂] against cancer, we have proposed the following possible Schemes 1-5 to explain the activity of our metal complexes, ML₂ on malaria cysteine protease enzymes FP-2 and FP-3 as well as the chloroquine resistant strain W-2. Since the metal complex ML₂ is rather bulky, it is plausible to suggest a dissociative mechanism resulting into the formation of ML⁺ and L⁻ fragments. A similar mechanism was put forward to explain the activity of cis-[PtCl₂(NH₃)₂] in cancer chemotherapy.

L⁻ is a deprotonated dithio ligand shown in FIG. 2. The ML⁺ fragment consists of a metal atom with a three coordination. This is also shown in FIG. 2. The x-ray crystal structure of CoL₂ was taken. It shows the cobalt atom in a six-coordination configuration with the ligand acting as a tridentate NNS System. The corresponding atoms of the NNS ligands are trans to each other in a distorted manner. That is, the sulphur atoms, the pyridine ring nitrogen's and the imine nitrogen's. The degree of M-L bond strength will could affect bond dissociation and hence the degree of biological activity.

In addition, other factors such the lability and the size of the metal atom could influence the biological activity.

For instance, Cd (II)>Mn(II)>Zn(II)>Co(II)>Ni(II) in size. This more or less parallels the order for complex reactivity of ML₂ with W-2. The dramatic variation in the biological activity of the complexes implies a direct participation of the metal atom. Hence, it is more plausible to assume that ML⁺ fragment probably exerts more influence in the biological activity than the ligand L⁻, and ML₂ complex. In conclusion, a lot more extensive work is needed to clearly understand the factors and mechanisms that influence the biological activity of the ligand, L⁻ and its corresponding metal complex, ML₂. The proposed possible mechanisms by which the metal complexes affect the parasite are summarized in Schemes 1 to 5 and condensed in Scheme 6. The malaria parasite decomposes human hemoglobin to produce free heme fragments and peptides in its food vacuole. The proteins are utilized by the parasite for its growth and replication. The heme acts as a parasite waste and is thus toxic to the parasite. Its toxicity is thought to occur by the heme lysing the membranes and producing reactive oxygen intermediates (ROI) and interfering with other biochemical processes. The parasite neutralizes the toxicity of the heme by converting it into a hemazoin polymer also known as the malarial pigment through a process called biocrystallization. The action of chloroquine drug is its interference with these processes. Chloroquine enters the food vacuole of the parasite due to its enabling environment. The enabling environment includes the parasite transporters that assist in the uptake of chloroquine, the existence of a specific parasite receptor for binding chloroquine and acidity of the food vacuole that promotes the protonation of the chloroquine nitrogen atoms. A postulated mechanism by which this activity occurs is through the formation of a complex with the heme and hence preventing it from forming a non-poisonous hemozoin The complex formed between the heme and chloroquine is poisonous to the parasite. This results into the death of the parasite.

The mechanism we have proposed in schemes 1 to 5 involve the formation of complexes between the complex ML₂, the fragments ML⁺ and the ligand L⁻ on one hand with the parasite enzymes FP-2 and FP-3 , the heme, as well as the chloroquine resistant strain W-2 and its enzymes represented by WE-2 on the other. The complexes so formed will ultimately poison the parasite leading to its death.

### BRIEF EXPLANATION OF DRAWINGS

FIG. 1. Refers to the synthesis, characterization and biological results of Metal complex containing deprotonated 3-[1-(2-pyridyl) ethylidene] hydrazinecarbodithioate ligand (FIG. 1).

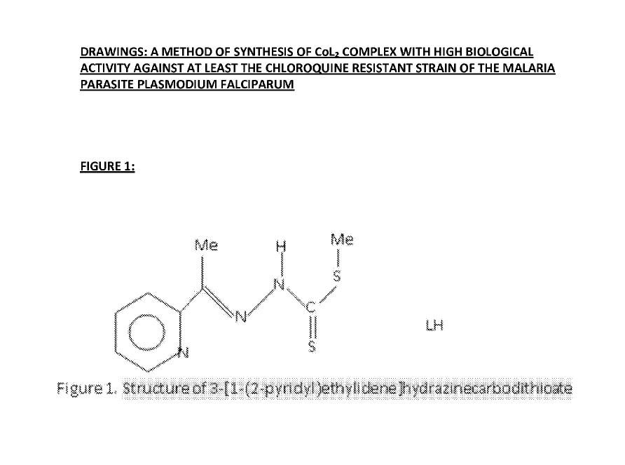

FIG. 2. Refers to the deprotonation process and mode of coordination of l−.

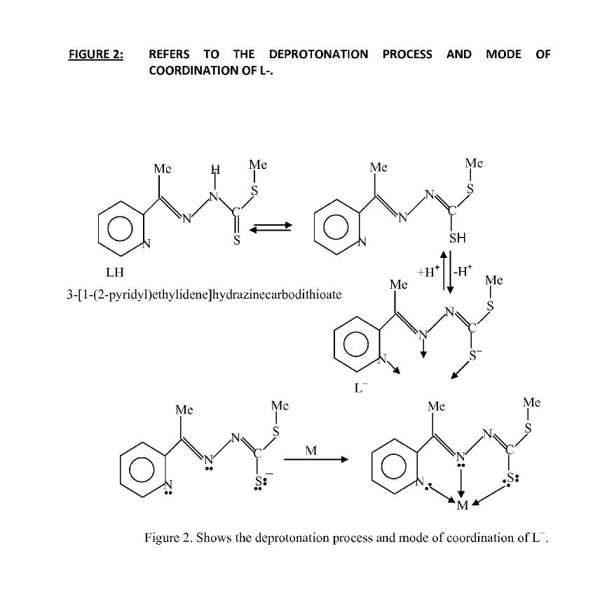

FIG. 3. Refers to positions where fragmentations can occur.

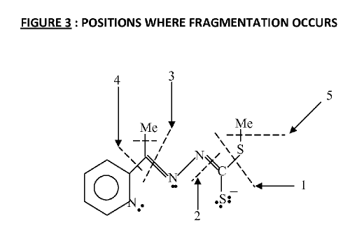

FIG. 4. Refers to the coupling of the pyridine hydrogens.

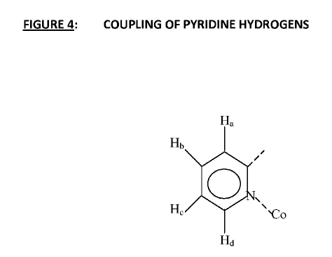

FIG. 5. Refers to the analytical data of and molecular mass of the complex synthesized and characterized.

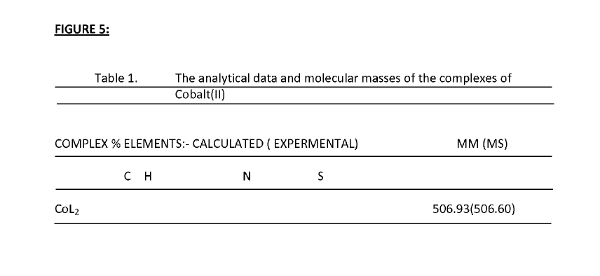

FIG. 6. Refers to the Biological Activity of the Metal Complex against the Malaria Parasite, Plasmodium Falciparum.

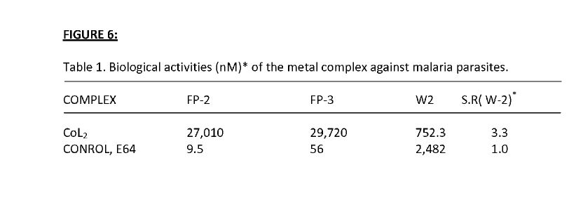

FIG. 7. Refers to the Mass Spectrum Fragmentation Patterns of the Metal Complex.

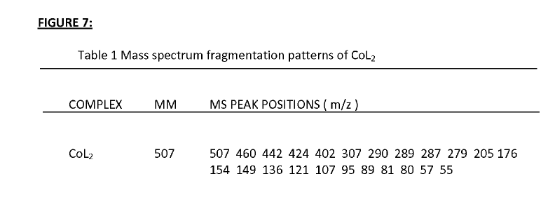

FIG. 8. Refers to the Mass Spectrum of CoL₂.

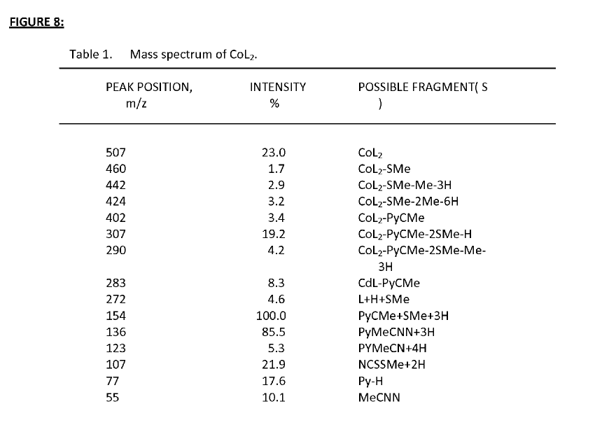

FIG. 10. Refers to the Infrared Spectra of CoL₂

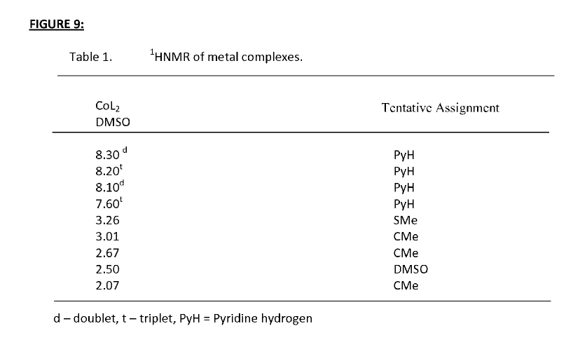

FIG. 11. Refers to the HNMR of CoL₂

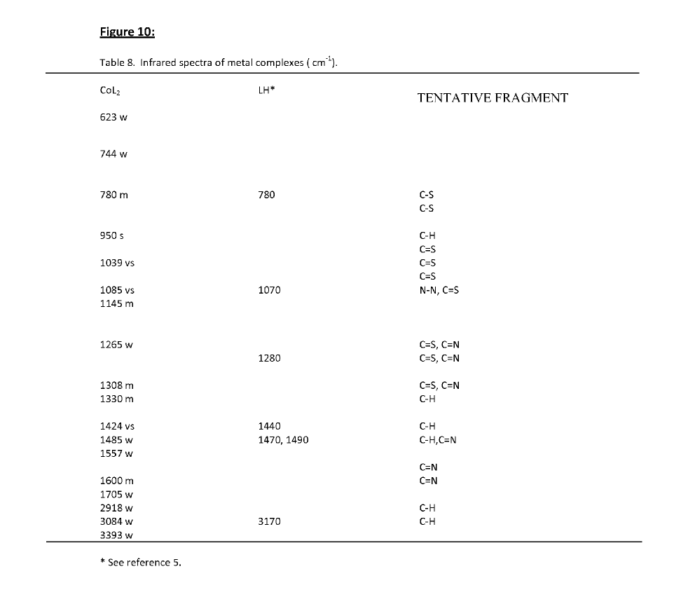

1-43. (canceled)

44. A method of producing a cobalt ligand complex (CoL₂) having biological activity against a malaria parasite includes providing a source of 3 - [1-(2-pyridyl) ethylidene] hydrazinecarbodithioate ligands (L), deprotonating the ligands to form deprotonated ligands (L−), contacting the deprotonated ligands with a cobalt compound under conditions suitable to form the cobalt ligand complex, and recovering the cobalt ligand complex so formed.

45. A method according to claim 44, wherein the cobalt compound is cobalt chloride hexahydrate.

46. A method according to claim 44, wherein the source of ligands (L−) and cobalt compound are provided respectively in solution, the respective ligand and cobalt solutions being mixed together with the addition of water to form a precipitate of the cobalt ligand complex.

47. A method according to claim 46, wherein the cobalt compound is dissolved in water to form the cobalt solution and the source of ligands is dissolved in ethanol to form the ligand solution.

48. A method according to claim 46, wherein the cobalt ligand complex precipitate is filtered off, washed, dried, and then recrystallized.

49. A method according to claim 48, wherein the cobalt ligand complex precipitate is recrystallized from acetone.

50. A method according to claim 44, wherein the cobalt ligand complex is potent against the malaria parasite plasmodium falciparum.

51. A method according to claim 44, wherein the cobalt ligand complex is potent against the chloroquine resistant strain (W-2) of the malaria parasite plasmodium falciparum.
